(19) United States
(12) Patent Application Publication
(10) Pub. No.: US 2012/0193359 A1
(43) Pub. Date: Aug. 2, 2012

(54) PLUG FOR CLOSING AND/OR SEALING AN OPENING IN A MEDICAL DEVICE, TREATMENT APPARATUS AND METHOD

(75) Inventor: Erwin MAI, Nuremberg (DE)

(73) Assignee: FRESENIUS MEDICAL CARE DEUTSCHLAND GMBH, Bad Homburg (DE)

(21) Appl. No.: 13/363,662

(22) Filed: Feb. 1, 2012

Related U.S. Application Data
(60) Provisional application No. 61/438,657, filed on Feb. 2, 2011.

(30) Foreign Application Priority Data
Feb. 2, 2011 (DE) 10 2011 010 149.7

(51) Int. Cl. B65D 53/00; B23P 11/00

(52) U.S. Cl. 220/233; 29/428

(57) ABSTRACT

The present invention relates to a plug for closing and/or sealing an opening in a medical device, produced from or at least comprising an elastic material, wherein the plug comprises at least one through-hole. The at least one through-hole is self-sealing and provided and/or embodied for passing at least one tool through it. The invention further relates to a method and a treatment apparatus.

### CROSS REFERENCE TO RELATED APPLICATIONS

This application claims priority to U.S. Provisional Application Ser. No. 61/438,657 filed Feb. 2, 2011 and German Patent Application No. 10 2011 010 149.7 filed Feb. 2, 2011, both of which are herein incorporated by reference in their entireties.

### FIELD OF INVENTION

The present invention relates to a plug for closing and/or sealing an opening. It further relates to a treatment apparatus, a method for producing or manufacturing a plug or for using a plug, respectively, and a method for actuating a component/joint connection being situated behind a plug in or on a medical device.

### BACKGROUND OF THE INVENTION

Medical devices regularly comprise components like screws that have to be accessible from the outside of the device. For different reasons, accesses or access openings to such components are closed by plugs in practice.

### SUMMARY OF THE INVENTION

One object of the present invention is to propose a plug that closes an access opening to components, joint connections like, e.g., screws, or the like of a device and still enables accessing the component or the joint connection.

The object according to the present invention is accomplished by means of a plug. The plug according to the present invention is produced from a flexible and/or elastic material—alternatively from a corresponding structure—or comprises such a material. The plug further comprises at least one self-sealing through-hole which is suited, provided and/or embodied for passing at least one tool through it.

The plug according to the present invention thus on the one hand closes access openings to components or joint connections like screws (hereafter, components in general as well as joint connections are also shortly referred to as screw for convenience). On the other hand, however, the plug advantageously enables accessing the screw for actuation by means of a corresponding tool, without the plug having to be removed or extracted from the access opening.

The treatment apparatus according to the present invention comprises at least one plug according to the present invention.

A method according to the present invention for producing at least one plug encompasses the integral production of a plug according to the present invention.

Another method according to the present invention for producing at least one plug encompasses producing, forming or shaping or molding, respectively, engraving, cutting or carving, shearing, punching and/or punching out, and so on, of a self-sealing through-hole in the plug.

The method according to the present invention for closing an opening by means of a plug according to the present invention encompasses arranging the plug in an opening within a first surface of an apparatus such that a second surface of the plug which comprises the through-hole or a section thereof is level or flush with the first surface.

The method according to the present invention for actuating a joint connection in or on a medical device by means of a tool encompasses passing the tool through a self-sealing through-hole of a plug according to the present invention. It further encompasses actuating a component or a joint connection, e.g., a screw, in a medical device behind the through-hole or after passing the tool through the through-hole.

Embodiments according to the present invention may comprise one or more of the following features.

In all of the following embodiments, the use of the expression may be or may have and so on, is to be understood synonymously with preferably is or preferably has, respectively, and so on, and is intended to illustrate certain embodiments according to the present invention.

In certain embodiments, a plug describes an object for permanently or temporarily, reversibly or irreversibly sealing and/or closing an opening, a through-hole or the like.

In some embodiments, a plug is embodied as a sealing plug.

The term self-sealing through-hole, as used herein in certain embodiments according to the present invention, describes a through-hole which, after the through-hole was opened in a first step, in a second step reseals automatically.

In some embodiments according to the present invention, a self-sealing through-hole is, e.g., a patch of the plug which in principle, i.e., if no external forces act on the through-hole, in particular exerted by means of a tool, is closed. The through-hole may, however, be penetrated mechanically and allow for temporary passage—e.g., for a tool—through the opening channel created thereby. After extraction or removal of the tool from the through-hole, the temporary opening channel reseals. Resealing may be effected, e.g., by means of the elastic material properties of the plug and/or by means of the special arrangement of plug sections. Active support of the re-sealing process by the user is not necessary for its re-sealing. The through-hole rather reseals automatically.

In certain embodiments according to the present invention the through-hole is an opening which is already provided or created during manufacture of the plug according to the present invention.

In some embodiments according to the present invention the through-hole is characterized by a lacking material bond or adhesive joint of their edges which contact one another during self-closure. The lacking material bond exists in some embodiments according to the present invention already upon completion of the manufacture and/or already before the plug is used for the first time.

In some embodiments according to the present invention the through-hole comprises an elongated, slit-like shape. In certain embodiments according to the present invention, the through-hole does not comprise a circular or elliptical cross-section.

In certain embodiments according to the present invention the plug according to the present invention is provided for being—completely or not completely—inserted into an interior of the recess for sealing the recess. In doing so, the plug seals the recess—preferably exclusively—from inside or out of the interior of the recess. In these embodiments, the plug is not coupled to and/or is not in contact with an exterior sheathing or boundary of the recess.

In some embodiments according to the present invention the through-hole is not provided and embodied for the passing through of cannulas, but rather for the passing through of tools which are described herein.

In some embodiments according to the invention, the plug according to the invention has a circular cross-section. One or each cross-section of the plug may, however, also be oval, rectangular, square or of any other shape.

In certain embodiments according to the present invention, the plug in general or in at least one section thereof comprises the same, a similar or identical cross-section as the opening to be closed.

In some embodiments according to the present invention, the plug according to the present invention has at least two cross-sections differing from each other—at least in its size or area.

In some embodiments according to the present invention, the plug comprises at least one section having a conically extending outer periphery.

In certain embodiments according to the present invention, a surface of the plug comprising the through-hole or a section thereof rectangularly merges into lateral or side areas of the plug. This advantageously enables a particularly flush and balanced insertion of the plug into the opening of an apparatus.

In certain embodiments according to the present invention, a surface, and in particular an upper or outer surface of the plug comprising the through-hole or a section thereof, is an exclusively plane surface. This embodiment advantageously contributes to the tightness of the self-sealing through-hole.

In certain embodiments according to the present invention, the plug according to the present invention is produced from or at least comprises a synthetic material.

In some embodiments according to the present invention, the plug according to the present invention is made of or comprises a thermoplastic synthetic material, in particular a thermoplastic elastomer (TPE).

In some embodiments according to the present invention, the plug according to the present invention may be made of or comprise the thermoplastic elastomer TPE Allruna W60.

The rigidity of the plug according to the present invention in certain embodiments according to the present invention corresponds to a shore value of 60 +/−5 (determined, e.g., according to at least one of the standards ISO 868, DIN ISO 7619, ASTM D 2240).

In some embodiments according to the present invention the plug according to the present invention is designed to be symmetric with regard to its rotational axis.

In some embodiments the plug according to the present invention is provided for sealing without any contact, adhesion, force closure or form-lock with a screw, or its head, which is located in the recess. In particular, in some embodiments of the plug according to the present invention, no opening is provided therein through which a joint connection or a fastener, for example a screw, is passed during intended use of the plug.

In some embodiments according to the present invention the plug according to the present invention is designed and provided for being connected with a recess of the medical device without any contact, adhesion, force closure or form-lock with a joint connection or a fastener, for example a screw, and/or it is used this way.

In some embodiments according to the present invention, the through-hole is a slit. In certain embodiments according to the present invention, the length of the slit is between 6 mm and 10 mm, in particular, it is 8 mm long.

The self-sealing through hole, e.g., in the shape of a slit, in some embodiments according to the present invention is arranged on or at the surface of the plug.

In some embodiments according to the present invention, the self-sealing through-hole comprises one and/or two sealing lips which seal the through-hole. The sealing lip or the sealing lips may be made of an elastic material.

In some embodiments according to the present invention, the through-hole is factory-made and/or created, produced or realized before the first use.

In certain embodiments according to the present invention, a tool describes work equipment for acting—in particular mechanically—on objects or joint connections like, e.g., screws, for example, for tightening a screw, for loosening a screw, for moving or adjusting a screw, and so on.

In some embodiments according to the present invention, a tool describes work equipment provided for acting on non-living objects or non-living tissue or fabric, respectively, in particular mechanically.

In certain embodiments of the present invention, the tool is a screwdriver or wrench.

The screwdriver may comprise different head shapes. In particular, the screwdriver may be embodied for use with slotted screws, socket or Allen or hexagon screws, cross-head or Phillips screws, square or Robertson screws, torx screws or screws having other shapes.

In some embodiments of the present invention, the tool is actuated manually. The tool may also be actuated electrically and/or pneumatically.

In certain embodiments according to the present invention, the tool is provided and or embodied for actuating adjusting screws, potentiometer screws, or the like. Adjusting screws may, e.g., be used for securing, maintaining and/or determining the distance between two components.

In some embodiments according to the present invention, the tool is provided and/or embodied for carrying out adjustments or for adjusting settings, e.g., with or of measurement devices or displays.

In certain embodiments according to the present invention, the through-hole is not designed or provided for being penetrated by a cannula or a needle.

In certain embodiments according to the present invention, the self-sealing through-hole is embodied as a self-sealing liquid seal.

A liquid seal (liquid-tight) in certain embodiments according to the present invention means that the through-hole is so tight that a drop of liquid standing on the through-hole does not permeate through the through-hole onto its other side within one minute, ten minutes, or an hour.

In some embodiments according to the present invention, the self-sealing through-hole seals against ingress of liquid into the medical device and/or escaping of liquid out of the device.

Liquids against which the self-sealing through-hole seals may encompass disinfectants, blood, dialysis liquids, lavages or flushing liquids, or other liquids.

In some embodiments according to the present invention, the self-sealing through-hole seals against ingress of dirt.

In certain embodiments according to the present invention, the plug is embodied to be one-piece.

In some embodiments according to the present invention, the plug does not comprise a covering disk—in particular one which is embodied as one single piece.

In certain embodiments according to the present invention, the plug does not comprise a spraying or molding or injecting film.

In certain embodiments according to the present invention, the plug comprises a latching device.

A latching device may be a ledge at or on the plug that elastically deforms when being inserted into an opening and subsequently, when the plug is in or is on its way to its position of use or end position, latches or snaps or locks in or with the housing of the opening (or the medical device).

In some embodiments according to the present invention, the latching device is a snapping device.

In certain embodiments of the plug according to the present invention, the latching device may prevent the plug from detaching from the opening automatically or on its own, i.e., without external influence. Thus, e.g., a permanent seal of the opening may advantageously be maintained by means of the latching device.

In some embodiments according to the present invention, the latching device is a device by means of which the plug grips or clasps or reaches behind a wall, a protrusion or the like of the apparatus in which it is inserted.

In some embodiments according to the present invention, the latching device of the plug is embodied such that the plug may be removed from the opening again, e.g., by elastically re-deforming the latching device by means of mechanical application of force.

In certain embodiments according to the present invention, the through-hole is created (for instance, by cutting, lasering, punching, and so on) after the production or the manufacture of the base body of the plug which may have taken place, e.g., by injection molding.

In some embodiments according to the present invention, the method for producing encompasses creating, forming or shaping or molding, respectively, engraving, cutting or carving, shearing, punching and/or punching out, and so on, of the through-hole without removal or erosion, respectively, of material, in particular free of chips or splinters. In certain embodiments according to the present invention, upon sealing no contact, no form-lock and/or no adhesion or force closure is created between the plug and a joint connection such as a screw by means of the plug according to the present invention.

In some embodiments according to the present invention, no rotary movement of the plug is achieved and/or the plug does not rotate while acting on the joint connection by means of a tool which has been passed through the through-hole.

In certain embodiments, the medical device is a therapy or treatment apparatus, in particular a blood treatment apparatus, in particular provided for performing a hemodialysis, hemofiltration or hemodiafiltration on a patient. A medical device may also be a blood pump, an X-ray device or any other device in the field of medical technology.

In some embodiments, the medical device is a therapy or treatment apparatus comprising an access opening for a component, e.g., a screw, with a component arranged therein, wherein the access opening is closed against an exterior by means of a plug according to the present invention.

Certain embodiments according to the present invention comprise one or more of the following advantages.

The present invention provides a plug for closing and/or sealing an opening in a medical device. The plug comprises a self-sealing through-hole for passing a tool through. By means of the tool, e.g., screws of the medical device being situated behind the plug may be actuated through the plug without the plug having to be removed from the opening. A possibly cumbersome removal of the plug from the device in order to loosen or tighten a screw covered by the device may advantageously be omitted. Thus, the risk of losing a plug removed for actuating a screw or the like is advantageously avoided.

With the present invention, it is further advantageously possible to arrange screws that are accessible from the exterior (in relation to the medical device) opposite to the wall of the housing of the medical device in a countersunk manner and cover them by means of a plug according to the present invention, wherein a substantially even or plane housing surface is created. A plane housing surface is of advantage when it comes to cleaning and/or disinfecting especially medical devices, as, unlike in the state of the art, there is no need for a withdrawal device or removal aid, respectively, such as a depthing, a handle, a protrusion, or the like, where a tool may be positioned in order to remove the plug from the opening—the plug according to the present invention does not have to be removed. To put it simply, it is in no situation in the way.

In certain embodiments of the present invention, ingress of liquids, e.g., blood, disinfectant, cleaning liquids or other liquids, into the interior of the medical device is advantageously avoided, even if a joint connection being situated behind the plug has already been actuated through the through-hole once by means of a tool. This advantageous effect is a result of the self-sealing function of the through-hole in the plug in certain embodiments.

Besides liquids, ingress of dirt, dust, etc. is also advantageously avoided due to the plug and the self-sealing through-hole in the plug.

In certain embodiments of the present invention, the plug is embodied to be one-piece. Thus, exchanging the plug, for instance if the plug and/or the self-sealing sealing lip was damaged, is advantageously easily possible.

Producing a one-piece plug may also be easier than producing a multi-piece plug.

In certain embodiments of the present invention, the plug according to the present invention for closing and/or sealing an opening in a medical device by means of the self-sealing through-hole for passing at least one tool through is not removed before, during or after the actuation of screws in the medical device. Thus, it is advantageously avoided that the plug is or gets contaminated, damaged or lost elsewhere, as may be the case with removable plugs.

Due to the self-sealing through-hole according to the present invention in the plug, advantageously no additional covers for the plug are necessary for sealing. For example, no hinged lids, additional sealing membranes or similar devices are necessary. Such additional parts may, e.g., wear out or become leaky after multiple use, or they are not as easy to be cleaned as even or smooth surfaces without additional parts as they are proposed according to the present invention.

In certain embodiments of the present invention, the screws that are to be actuated through the through-hole by means of the tool are adjusting screws, potentiometer screws, etc., which should be repeatedly accessible for vernier adjustments. The plug according to the present invention advantageously enables the necessary access to the screw or component without the housing having to be opened.

### BRIEF DESCRIPTION OF THE DRAWINGS

In the following, the present invention is exemplarily explained by means of the figures of the appended drawings, in which identical reference numerals refer to same or identical components. In the partly simplified figures, it applies:

FIG. 1 shows a perspective general view of a plug according to the present invention having a self-sealing through-hole.

FIG. 2a shows a bottom view, and FIG. 2b shows a sectional view of the plug of FIG. 1.

FIG. 3a-3c show passing through of a tool through a self-sealing through-hole of the plug of FIG. 1.

FIG. 4 shows a sectional view of a plug according to the present invention in the state of use.

FIG. 5 shows another sectional view of a mounted plug according to the present invention in a housing in a slightly perspective view.

FIG. 6 shows a general view of the plug in the housing of FIG. 5.

### DETAILED DESCRIPTION OF THE DRAWINGS

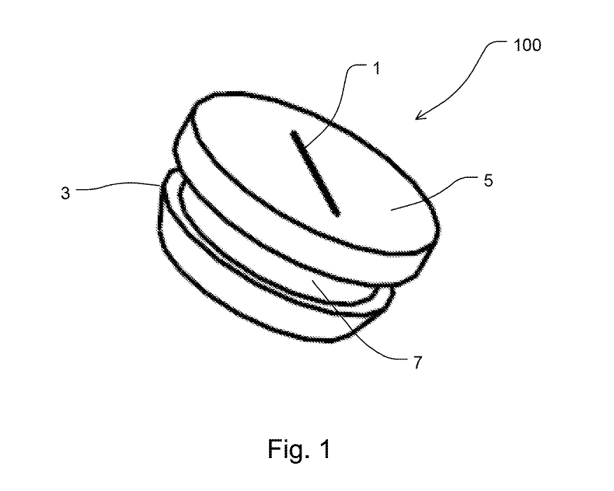

FIG. 1 shows a perspective general view of a plug 100 according to the present invention having a slit as a self-sealing through-hole 1 extending to a surface 5 of the plug 100.

The plug 100 is—merely exemplarily—represented having a circular cross-section. The plug 100 has a ledge 3, which is provided for gripping or clasping or reaching behind a wall of a housing or behind a different section of an apparatus as a latching device during insertion of the plug 100. The surface to be sealed of the housing or the apparatus in this exemplary embodiment interlocks with a rotationally symmetric sealing surface 7. In its embodiment shown in FIG. 1, the plug 100 may, e.g., be used for sealing a surface having a circular opening.

The plug 100 is made of or comprises an elastic material, at least in the area of the ledge 3 and/or its through-hole 1, so that it may be deformed in the area of the ledge 3 and pressed or pushed into an opening of the housing. An elastic material used according to the present invention is, e.g., an elastic synthetic material, e.g., a thermoplastic elastomer.

In the example of FIG. 1, the surface 5 of the plug 100 is provided and embodied for forming a plane surface with the surface of the housing to be sealed (not shown in FIG. 1). A plane surface may, e.g., advantageously facilitate cleaning the housing surface.

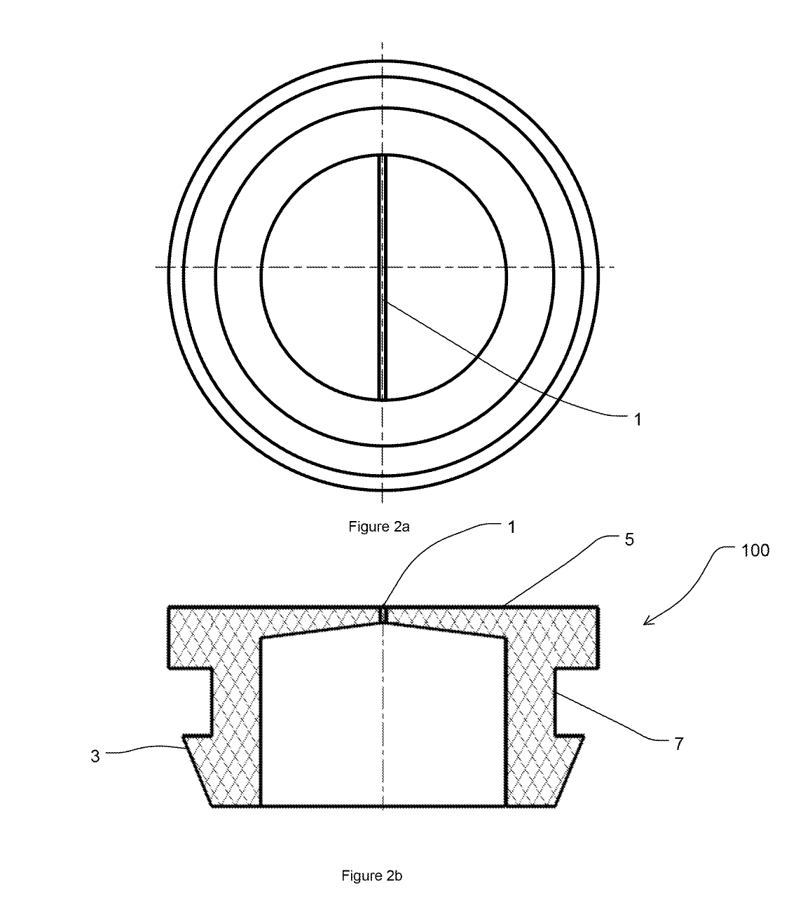

In FIG. 2a, a bottom view of the plug 100 is represented. In FIG. 2b, a sectional view of the plug 100 is represented.

In FIG. 2, the self-sealing through-hole 1 can be recognized being a slit. According to the present invention, this slit is self-sealing due to its geometry and the elastic material properties of the plug. This means that the slit has a given or finite width when being created or produced, e.g., by means of a cut with the help of a stamping or punching blade. This width is shown in the representation of FIG. 2. After removal of the stamping or punching blade, the slit shown in FIG. 2 seals and forms the self-sealing through-hole 1 according to the present invention.

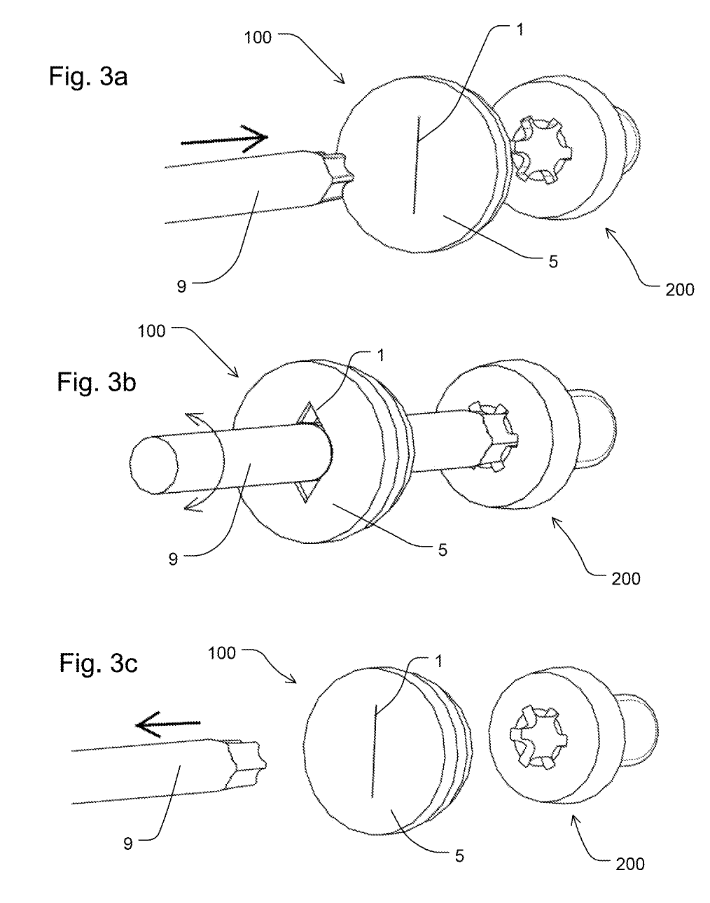

FIGS. 3a, 3b and 3c show three successive steps of passing and using a tool through the self-sealing through-hole 1 of the plug 100 as shown in FIG. 1.

In FIG. 3, the general function or use of the plug 100 is exemplarily explained by means of the three steps. The housing or device in which the plug 100 closes or seals, e.g., an opening, is not shown. Neither is the mechanical, electrical or in an otherwise occurring mode in which the tool is actuated.

In FIG. 3a, a tool 9, shown in this exemplary embodiment as a screwdriver or wrench for torx screws, is lead towards the self-sealing through-hole 1 of the plug 100 in the direction of the arrow.

In FIG. 3b, the tool 9 is passed through the self-sealing through-hole 1 of the plug 100 and positioned onto the screw head of a screw 200.

The double-arrow in FIG. 3b indicates that the tool 9 for tightening or loosening the screw 200 may be turned in one direction or the other.

In FIG. 3c, it is shown that the through-hole 1 reseals according to the present invention when the tool 9 is pulled back through the self-sealing opening 1 of the plug 100 after actuation of the screw 200. Thereby, e.g., ingress or escaping of liquids may advantageously be avoided.

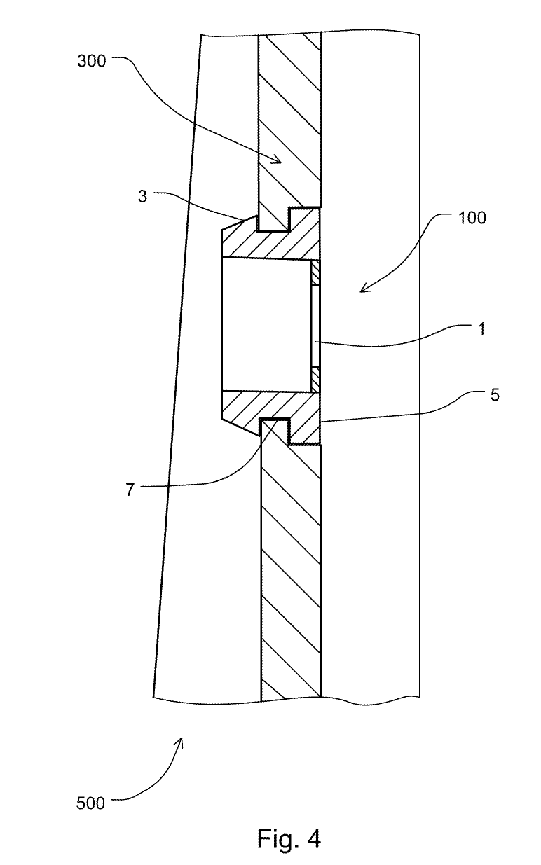

FIG. 4 shows a sectional view of a plug 100 according to the present invention, arranged for use in a housing 300, shown only partially, of a treatment apparatus 500 according to the present invention.

On the right (referring to the representation in FIG. 4), the surface or the exterior of the housing 300 is located. The plug 100 according to the present invention is inserted from this side. The ledge 3 is being compressed to the diameter of the sealing surface 7 during the insertion process of the plug 100. When the plug 100 subsequently is completely compressed or has reached its end position, the ledge 3 latches or snaps or locks in or with the housing. The sealing surface 7 then is interlocking with the opposite housing face or area and causes a sealing effect of the plug 100. The plug surface 5 is flush with the housing surface. This may, e.g., advantageously facilitate cleaning the housing surface.

In FIG. 4, the through-hole 1 is vertical. Those areas of the plug surface 5 which regarding the representation of FIG. 3a or 3c are above or below, respectively, the through-hole 1, are therefore represented in sectional view.

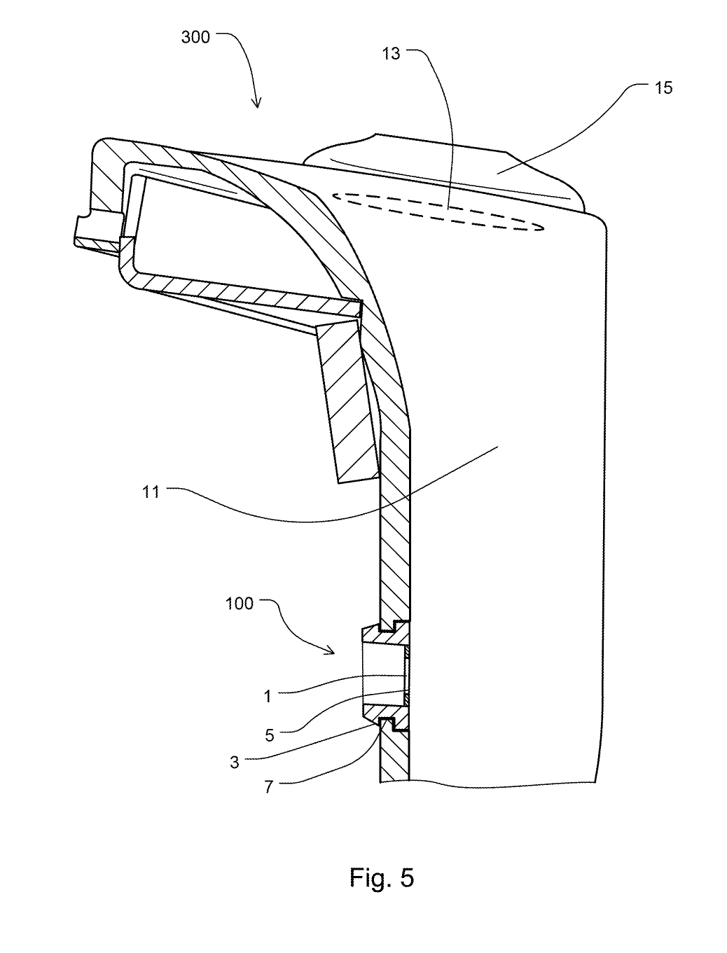

FIG. 5 shows a further sectional view of a mounted plug 100 according to the present invention in a housing 300 of the treatment apparatus 500 indicated in FIG. 4 having an additional opening 13 of the housing. The opening 13 of the housing is closed by a seal 15.

In FIG. 5, it is easy to recognize that the plug surface 5 is flush with the housing surface 11.

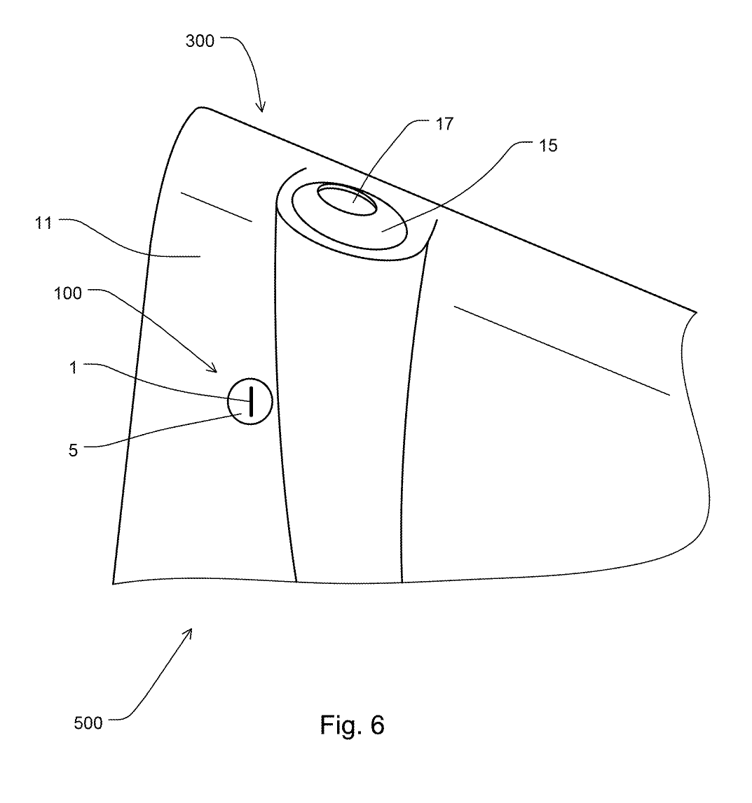

FIG. 6 shows a general view of the plug 100 in the housing 300 shown in FIG. 5.

When setting up the corresponding apparatus, at first, its housing 300 is sealed tightly by inserting the seal 15 and the plug 100 according to the invention into their respective openings. In a subsequent step, e.g., an infusion rod or infusion pole is introduced into the housing through an opening 17 which, e.g., is sealed by one or more membranes in the seal 15 of the housing. This infusion rod or infusion pole is fixated in the interior of the housing by means of adjusting screws. This adjusting screw (or these adjusting screws, in case there are more than one) may advantageously be accessed through the through-hole 1 according to the present invention of the plug 100. For this, the plug 100 does not have to be removed. The adjusting screw of the infusion pole holder is tightened. In this way, the infusion pole is fixed or fixated in the housing. It may be adjusted through the plug 100 and newly aligned in its height adjustment.

Reference numeral list

| reference numeral | description |
|---|---|
| 100 | plug |
| 200 | screw |
| 300 | housing |
| 500 | treatment apparatus |
| 1 | self-sealing through-hole |
| 3 | ledge; as a latching device |
| 5 | plug surface |
| 7 | sealing surface of the plug |
| 9 | tool |
| 11 | housing surface |
| 13 | additional opening of the housing |
| 15 | seal |
| 17 | opening in the seal |

1-10. (canceled)

11. A plug for closing or sealing an opening in or on a medical treatment apparatus comprising:
a flexible or elastic material comprising at least one through-hole,
wherein the at least one through-hole is self-sealing, and is configured to receive at least one tool therethrough.

12. The plug according to claim 11, wherein the self-sealing through-hole is configured to be a liquid seal.

13. The plug according to claim 11, wherein the plug is one-piece.

14. The plug according to claim 12, wherein the plug is one-piece.

15. The plug according to claim 11, wherein the plug further comprises:
a latching device for latching the plug to a housing or a different section of an apparatus.

16. A medical treatment apparatus, comprising:
at least one plug for closing or sealing an opening in or on the blood treatment apparatus comprising:
a flexible or elastic material comprising at least one through-hole, wherein the at least one through-hole is self-sealing, and is configured to receive at least one tool therethrough.

17. The medical treatment apparatus of claim 16, wherein the apparatus is a hemodialysis device, a hemofiltration device, or a hemodiafiltration device.

18. The apparatus according to claim 16, wherein the self-sealing through-hole is configured to be a liquid seal.

19. The apparatus according to claim 16, wherein the plug is one-piece.

20. The apparatus according to claim 16, wherein the plug further comprises:
a latching device for latching the plug to the apparatus.

21. A method for producing or manufacturing at least one plug, comprising the step of:
providing a flexible or elastic material;
integrally producing a plug therefrom; and
forming or cutting a self-sealing through-hole in the plug.

22. A method for closing an opening comprising the steps of:
providing the plug of claim 11; and
arranging the plug in an opening of a first surface of an apparatus,
wherein a second surface of the plug comprises the through-hole or a section thereof, and
wherein said second surface is flush with the first surface when the plug is arranged in the opening.

23. The method according to claim 22, wherein the self-sealing through-hole is configured to be a liquid seal.

24. The method according to claim 22, wherein the plug is one-piece.

25. The method according to claim 22, wherein the plug further comprises:
a latching device for latching the plug to the apparatus.

26. A method for actuating a component or a joint connection situated in a recess of a medical device, comprising the steps of:
providing the plug of claim 11;
passing a tool through the self-sealing through-hole of the plug; and
actuating the component or joint connection situated in the recess behind the through-hole with the tool.

27. The method according to claim 26, wherein the joint connection is a screw.

28. The method according to claim 26, wherein the self-sealing through-hole is configured to be a liquid seal.

29. The method according to claim 26, wherein the plug is one-piece.

30. The method according to claim 26, wherein the plug further comprises:
a latching device for latching the plug to the apparatus.
